(19) United States
(12) Patent Application Publication
(10) Pub. No.: US 2018/0352177 A1
(43) Pub. Date: Dec. 6, 2018

(54) IMAGE-PROCESSING DEVICE

(71) Applicant: HITACHI KOKUSAI ELECTRIC INC., Tokyo (JP)

(72) Inventors: Yuichiro KOMIYA, Kodaira (JP); Muneaki YAMAGUCHI, Kodaira (JP)

(73) Assignees: HITACHI KOKUSAI ELECTRIC INC., Tokyo (JP); HITACHI KOKUSAI ELECTRIC INC., Tokyo (JP)

(21) Appl. No.: 15/757,933

(22) PCT Filed: Sep. 8, 2016
(86) PCT No.: PCT/JP2016/076445

§ 371 Date: Mar. 6, 2018

(30) Foreign Application Priority Data
Sep. 18, 2015 (JP) 2015-185427

(51) Int. Cl. H04N 5/357; G06K 9/32; G06N 3/08; G06T 7/00; G06T 7/246

(52) U.S. Cl. CPC H04N 5/357; G06K 9/3241; G06T 7/246; G06T 7/0002; G06N 3/08

(57) ABSTRACT

An image-processing device for performing correction processing and event detection adaptively to the effect of a disturbance that an input image has received is disclosed. The device has a disturbance detection unit, an image correction unit, and an event detection unit. The disturbance detection unit analyzes an input image, detects the effects of a plurality of disturbances that the input image has received, and outputs the detected effects as disturbance information. The image correction unit applies correction processing to an input video in accordance with the disturbance information, and outputs a corrected image and correction information indicating the actually applied correction. The disturbance detection unit estimates the degree of the plurality of disturbances residual in the corrected image from the disturbance information and the correction information, and detects a specific event using a detection process selected in accordance with the degree of disturbances. The plurality of disturbances are three that includes, for example, a mist, heat haze, and noise.

### TECHNICAL FIELD

The present invention relates to an image-processing device.

### BACKGROUND ART

In recent years, there is a growing need for a function to automatically detect an event from video footage of monitoring cameras. Such automatic detection functions include a technique to detect abnormal action of a subject in video and a technique to detect only a particular person captured by the monitoring camera, for example.

In order to maximize the performance of these detection techniques, it is thought to be preferred that input images are of high quality. However, monitoring cameras are actually installed at various places. Images taken by monitoring cameras, especially installed outdoors, degrade in some cases due to illumination conditions which change with varying weather conditions and over time as well as disturbances such as fog and heat haze. Meanwhile, sufficient resolution cannot be obtained for subjects required to be observed in some cases depending on installation locations of the cameras or focal length (zoom ratio) of lenses. In such a case, the accuracy of the detection technique is degraded, sometimes causing detection failure and the like.

To address the aforementioned problems, techniques to correct the degraded images and techniques to improve the image quality are being developed, including: a fog correction technique, a heat-haze correction technique, and an image sharpening technique, for example. The fog correction technique is a technique able to restore the contrast reduced due to fog or the like. The heat-haze correction technique is a technique to correct the subject's distortion generated by heat-haze or the like. The image sharpening technique is a technique to improve the resolution or visual resolution of images through adaptive edge enhancement.

These techniques are to improve the visibility of monitoring cameras but do not always yield good effects. The fog correction technique sometimes enhances noise components through contrast enhancement. The heat-haze correction technique sometimes produces blur in a region where a moving object exists. The image sharpening technique sometimes enhances noise components in an image including a lot of noise components.

These image processing techniques adaptively perform different processes in accordance with the situation of each part of the screen, and the amount of computation thereof is not necessarily small. Executing all the processes using a calculator of low processing capacity reduces the real-time operating performance.

As one of the prior art literatures, for example, Patent Literature 1 discloses an invention which is able to detect abnormalities in image conditions even when the input image becomes inappropriate for operation of the monitoring system due to a change in the natural environment and the like and recognizes abnormalities in the monitoring environment.

As another prior art literature, for example, Patent Literature 2 discloses an invention that performs tone correction on an image with the contrast entirely or partially reduced, for reliable detection of an object. Patent Literatures 3 and 4 disclose inventions of heat-haze correction based on time averaging.

### CITATION LIST

### Patent Literature

Patent Literature 1: JP 5710230B

Patent Literature 2: JP 2013-186635A

Patent Literature 3: JP 2014-206772A

Patent Literature 4: JP 5787456B

### SUMMARY OF INVENTION

### Technical Problem

As described above, the correction processes for an input image that are intended to improve the performance of event detection, require considerable processing costs. Additionally, in the cases where the input image is not exposed to disturbance, such a process is unnecessary or is likely to even degrade the image quality or detection performance. The way of optimally implementing those processes with limited hardware resources is not sufficiently established yet. Although the optimization is desired to be automatically performed for each video source, it is difficult for the method of Patent Literature 1, which previously determines items used to diagnose the video conditions, to exhaustively consider a large number of factors. In applications such as security monitoring, the false alarm rate and miss rate, which are particular factors having a trade-off relationship, need to be considered. Generally, it is preferred that more critical events be detected with a lower miss rate.

Furthermore, it is difficult to design correction processes for input images so as to maintain or enhance the performance of detecting a desired event in applications that determine a large number of classes or in cases of using deep learning. Such a classifier may internally use image features hardly perceptible with human visual sense, and increasing the visual image quality may be meaningless. Detection can be significantly influenced rather by differences in the optical imaging environment including the zoom ratio and aperture, image processing performed within the camera without being desired, and the like.

An object of the present invention is to appropriately perform a pre-processing in order to detect an event in an image using premised hardware.

### Solution to Problem

An image-processing device of the present invention is an image-processing device including a disturbance detection unit, an image correction unit, and an event detection unit. The image correction unit uses different methods to correct images depending on disturbance information outputted from the disturbance detection unit. The disturbance information is disturbance levels, for example. Based on the disturbance levels and each correction method, residual disturbances or influences (false alarms or misses) thereof given to event detection are evaluated. The image-processing device automatically determines an optimal correction method which yields allowable residual disturbances or influences and is implemented by given hardware.

The disturbances include reduction in contrast due to fog, distortion of a subject due to heat haze, and noise enhancement due to gain-up under low illumination, for example. The disturbances are not limited to these and can also include indirect influences on the camera due to changes in the target and environment.

As an example, the influence of fog is estimated from the imbalance of contrast between plural blocks as divisions of the screen. The influence of heat haze is estimated by comparison of difference information of the histogram and difference information of pixel values for each block. The influence of noise is estimated from parameters of the imaging unit. These estimations are desirably performed with sufficiently low processing costs and are not required to be processed in real-time or on all the frames.

The detection unit can be implemented by a convolution neural network and may be configured to learn in operation.

### Advantageous Effects of Invention

According to the present invention, it is possible to perform appropriate correction in accordance with influences of disturbances on the input image for event detection.

### BRIEF DESCRIPTION OF DRAWINGS

FIG. 1 is a block diagram of an image-processing device 1 according to an embodiment.

FIG. 2 is a block diagram of a disturbance detection unit 102 of the image-processing device 1.

FIG. 3 is a diagram for explaining images analyzed by the disturbance detection unit 102.

FIG. 4 is a flowchart of analysis image acquisition by an analysis image extraction unit 201.

FIG. 5 is a block diagram of a fog influence detection unit 202 of the image-processing device 1.

FIG. 6 is a block diagram of a heat-haze influence detection unit 203 of the image-processing device 1.

FIG. 7 is a flowchart of the method to determine disturbance levels in the image-processing device 1.

FIG. 8 is a block diagram of an event detection unit 104 of the image-processing device 1.

FIG. 9 is a diagram for explaining the operation of threshold function T( ) in a detection processing unit 503.

FIG. 10 is a block diagram of an image-processing device 101 according to a second embodiment.

FIG. 11 is a block diagram of an event detection unit 134 of the image-processing device 101.

### DESCRIPTION OF EMBODIMENTS

Hereinafter, a description is given of embodiments of the present invention in detail with reference to the drawings.

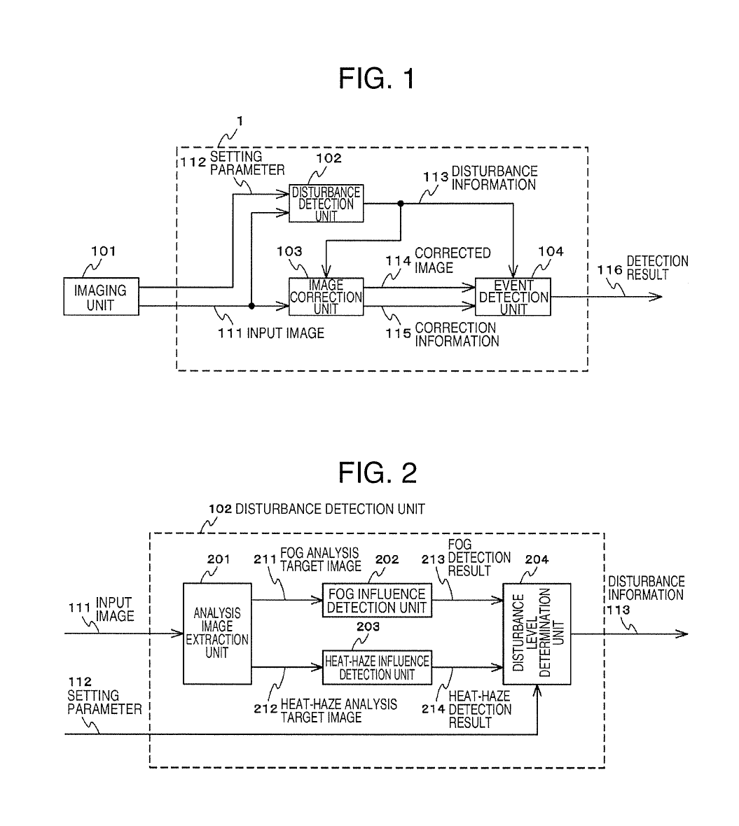

FIG. 1 is a block diagram of an image-processing device 1 according to an embodiment. The image-processing device 1 includes a disturbance detection unit 102, an image correction unit 103, and an event detection unit 104.

The image-processing device 1 detects an event in an input image (image signal) 111 received from an imaging unit 101 and outputs the detected event. The image-processing device 1 may be also implemented in such a manner that some of the functions thereof are assigned to the imaging unit 101 for distributed processing or in such a manner that one integrated server or the like performs centralized processing on input images inputted from a plurality of the imaging units 101, for example.

The imaging unit 101 takes a video of a subject and outputs the same as the input image 111 to the disturbance detection unit 102 and image correction unit 103. The imaging unit 101 also outputs setting parameters 112 used in the process of taking the video to the disturbance detection unit 102.

The disturbance detection unit 102 analyzes the input image 111 to detect influences of disturbances on the input image 111. The disturbance detection unit 102 outputs the detected influences to the image correction unit 103 and event detection unit 104 as disturbance information 113.

The above disturbances include fog, heat haze, and noise, for example. The disturbances may be estimated using the setting parameters 112 of the imaging unit 101.

The outputted disturbance information 113 represents the intensity of disturbances (the degree of degradation of the input image 111) in three levels (high, middle, and low) or the like, for example.

The image correction unit 103 performs correction on the input image 111 in accordance with the disturbance information 113 and outputs a corrected image 114 and correction information 115 to the event detection unit 104.

The correction uses processes to reduce influences of disturbances, such as fog correction and heat-haze correction, or a technique to improve image quality, such as sharpening (super-resolution). When the amount of processing of necessary image correction processes is greater than the amount of processing allowed for real-time operations, the image correction unit 103 prioritizes these processes based on the disturbance information 113 and performs only processes of high priority. The priorities of the processes are determined so that processes to correct more significant disturbances have higher priority, for example.

The correction information 115 is information representing correction processes actually performed for the input image 111. The correction information 115 can include not only whether to execute correction but also information such as the intensity of correction, the degree of improvement, and the range to which correction is applied.

The event detection unit 104 detects an event from the corrected image 114 in accordance with the disturbance information 113 and correction information 115.

The event detection unit 104 first estimates influences of disturbances remaining in the corrected image based on the disturbance information 113 and correction information 115. In accordance with the results of estimation, the event detection unit 104 adaptively changes the detection processes or parameters thereof.

Next, a description is given of the method to detect the influences of disturbances on the input image 111 with reference to FIGS. 2 to 6.

FIG. 2 is a block diagram of the disturbance detection unit 102 of the image-processing device 1 of the first embodiment.

In FIG. 2, the disturbance detection unit 102 includes an analysis image extraction unit 201, a fog influence detection unit 202, and a heat-haze influence detection unit 203, and a disturbance level determination unit 204.

The analysis image extraction unit 201 extracts from the input image 111, image blocks to detect influences of fog and heat-haze and outputs the extracted image blocks as a fog analysis target image 211 and a heat-haze analysis target image 212.

The disturbance level determination unit 204 determines reduction in contrast due to fog, distortion of the subject due to heat haze, and influences of noise due to gain-up under low illumination based on a fog detection result 213, a heat-haze detection result 214, and the setting parameters 112 and outputs the results of determination as the disturbance information 113.

The influence of noise on the input image is estimated based on the setting parameters 112 of the imaging unit 101. The signal-to-noise ratio (SN ratio) of the imaging unit 101 depends on the performance of the imaging sensor itself and is calculated using measurable parameters as follows according to NMVA1288.

$${SNR}_{y} = \frac{η {μ}_{p}}{\sqrt{( ( {σ}_{d}^{2} + {σ}_{o}^{2} ) + η {μ}_{p} + {S}_{g}^{2} {η}^{2} {μ}_{p}^{2} )}} \qquad [ MATH . 1 ]$$

Herein, μₚ is the number of incident photons; η, quantum efficiency; σ_{d}, dark noise (thermal noise σ_{d}c and readout noise σ_{d}0); σ₀, spatial off-set noise; and S_{g}, spatial gain noise. In a scene with low illumination, σ_{d} and σ₀ are dominant in the denominator. In a scene with moderate illumination, ημₚ in the denominator is relatively large, and SNR≅(ημₚ)^{1/2}. This indicates a region dominated by so-called optical shot noise. Under higher illumination, SNR is saturated to 1/S_{g}.

It is difficult to accurately calculate ημₚ or SNR from the brightness of the input image 111 subjected to AGC and the like. When the signal is subjected to gain-up in the imaging unit 101, for example, the noise level becomes high against the visual brightness. Accordingly, values that are related to the brightness of the input image 111 before being subjected to AGC and are used in the imaging unit 101, such as an analogue AGC control value (AGC gain), for example, can be used as the setting parameters 112. The AGC gain is desirably acquired for each frame. The SNR can be basically described by a function monotonically decreasing for the AGC gain even considering control by AE (automatic exposure).

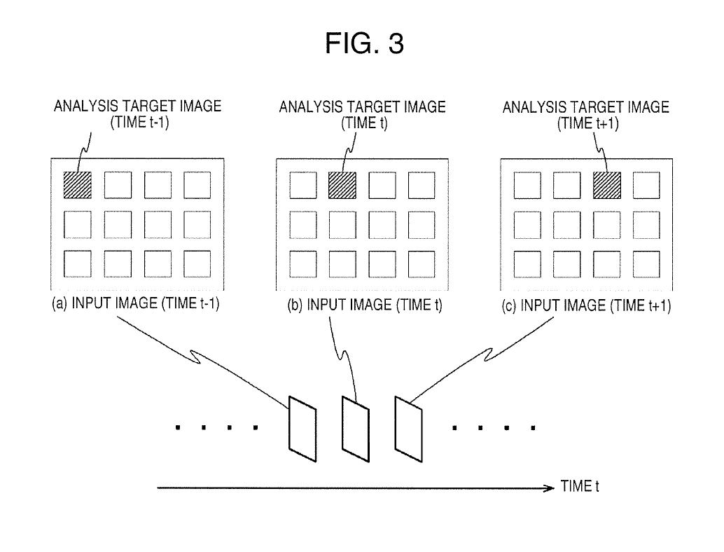

FIG. 3 is a diagram for explaining images analyzed by the disturbance detection unit 102. The input image 111 is evenly divided into a plurality of blocks.

(a) in FIG. 3 shows that one of the blocks (at the upper left corner) is used as an analysis target image (time t−1) at time t−1. (b) in FIG. 3 shows that another block different from the block used at the time t−1 (the next block on the right, for example) is used as an analysis target image (time t) at time t. (c) in FIG. 3 shows that still another block (the next block on the right, for example) is used as an analysis target image (time t+1) at time t+1.

The analysis image extraction unit 201 of FIG. 2 may divide the input image 111 into blocks as illustrated in FIG. 3, for example and extract one of the blocks as the analysis target image by sequential scanning. The analysis image extraction unit 201 is configured to analyze only one of the blocks during time corresponding to one input image (one frame), so that the amount of computation for disturbance detection can be reduced. The amount of time taken to analyze the entire input image therefore corresponds to a plurality of frames. However, such a configuration has no problem because the disturbance conditions usually change gradually with time.

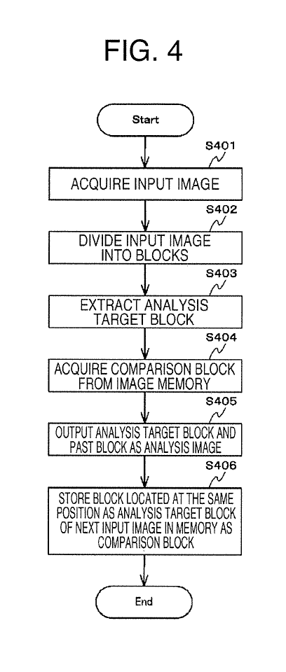

FIG. 4 is a flowchart of analysis image acquisition by the analysis image extraction unit 201.

In FIG. 4, the analysis image extraction unit 201 starts processing (START); acquires the input image 111 (S401); divides the input image 111 into a predetermined number of blocks (S402); extracts the analysis target block (S403); acquires (reads) a comparison block stored in a not-illustrated image memory (S404); outputs the analysis target block and a past block (a comparison block) as analysis images (S405); stores (writes) the block located at the same position as the analysis target block in the next input image 111 as the comparison block in a not-illustrated image memory (S406); and ends the processing (END).

Detection for some types of disturbances needs information of a plurality of frames at different times.

In such a case, the analysis image extraction unit 201 may store an image block at the same position as the position of the image block to be analyzed in the next input frame, in a not-illustrated image memory or the like, for example.

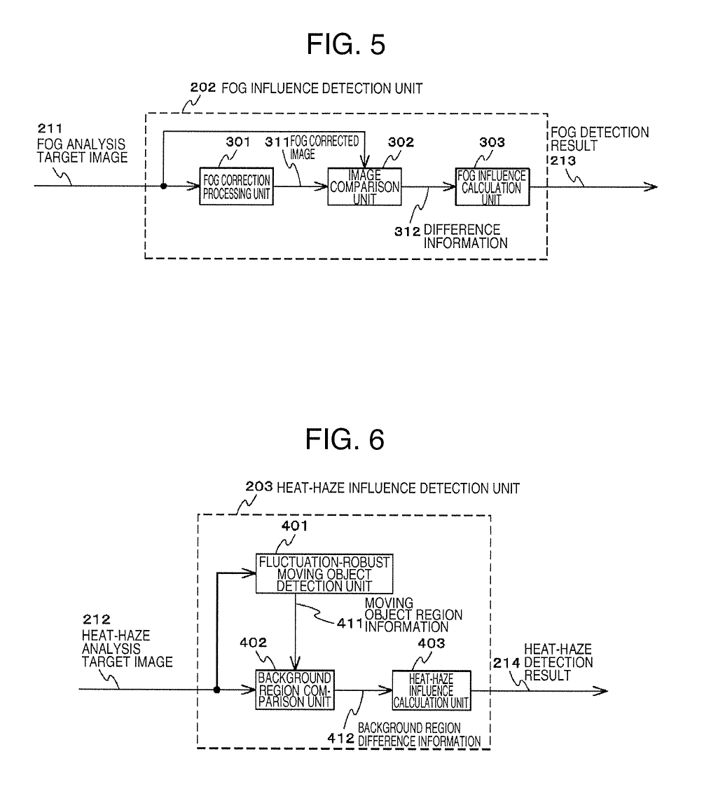

FIG. 5 is a block diagram of the fog influence detection unit 202 of the image-processing device 1.

The fog influence detection unit 202 detects an influence of fog based on the imbalance of contrast of the fog analysis target image 211 given from the analysis image extraction unit 201 and outputs the detected influence as a fog detection result 213.

The fog influence detection unit 202 includes a fog correction processing unit 301, an image comparison unit 302, and a fog influence calculation unit 303.

The fog correction processing unit 301 performs fog correction for the fog analysis target image 211 and outputs the result of fog correction as a fog corrected image 311. The fog correction generally includes tone correction and spatial filtering.

The image comparison unit 302 compares the fog analysis target image 211 with the fog corrected image 312 and outputs difference information 312 thereof. The difference information 312 is a processing result such as the sum of absolute differences (SAD), for example.

The fog influence calculation unit 303 calculates the fog detection result 213 from the inputted difference information 312 and outputs the same. Large values in difference information 312 correspond to high levels of fog correction, suggesting that the fog analysis target image 211 is degraded due to reduction in contrast. The fog detection result 213 is not limited to the result obtained as described above and may be calculated based on the imbalance or statistical dispersion in the histogram of pixel luminance values of the fog analysis target image 211 or based on a spatial frequency spectrum analysis.

FIG. 6 is a block diagram of the heat-haze influence detection unit 203 of the image-processing device 1.

The heat-haze influence detection unit 203 detects fluctuation in the background region where no moving object is detected, from the inputted heat-haze analysis target image 212, similarly to the techniques of Patent Literatures 3 and 4, to detect an influence of heat-haze. The heat-haze influence detection unit 203 outputs the detected influence as the heat-haze detection result 214.

The heat-haze influence detection unit 203 includes a fluctuation-robust moving object detection unit 401, a background region comparison unit 402, and a heat-haze influence calculation unit 403.

The fluctuation-robust moving object detection unit 401 detects a moving object from the inputted heat-haze analysis target image 212 and outputs the result as moving object region information 411. The heat-haze analysis target image 212 includes the analysis target image block of the current input image (at time t) and an image block located at the same position in the previous input image (at time t−1).

For example, the fluctuation-robust moving object detection unit 401 divides the heat-haze analysis target image 212 into sub-blocks of 32 by 32 pixels and creates histograms h₁ and h₂ of k gray levels for each sub-block. The fluctuation-robust moving object detection unit 401 compares two inputted sub-blocks in terms of the following expression to determine the region of C>T as a moving object.

[MATH. 2]

C=Σₖ₌₁^{K}|h₁(k)−h₂(k)| Ex. 1

The above equation uses the characteristics that the influence of fluctuations is robust to histograms. Even in the environment with fluctuations, the above equation (Ex. 1) enables extraction of only the moving object region.

The background region comparison unit 402 uses the inputted moving object region information 411 to calculate differences between the regions (sub-blocks) where no moving object is detected in two blocks of the heat-haze analysis target image 212, outputting the calculated differences as background region difference information 412. When conductors are detected in all the regions, the background region difference information 412 cannot be used temporarily.

The heat-haze influence calculation unit 403 calculates the influence of heat haze by averaging or another processing for the inputted background region difference information 412 and outputs the calculated influence as the heat-haze detection result 214. When conductors are detected in all the regions, the background region difference information 412 cannot be used temporarily.

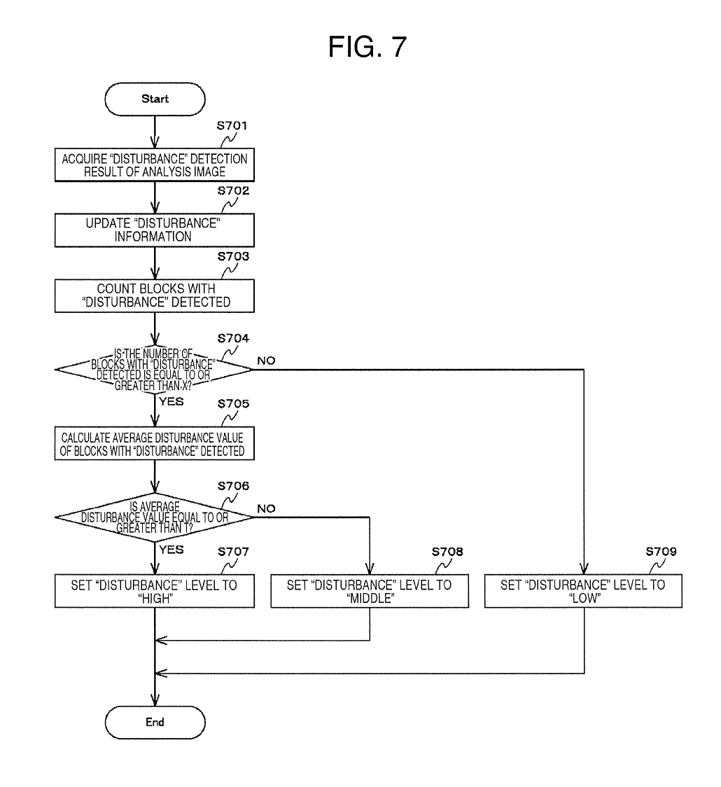

Next, a description is given of the procedure to determine disturbance levels of heat haze, fog, and the like from the analysis results of the image blocks with reference to FIG. 7.

FIG. 7 is a flowchart for explaining the method to determine disturbance levels by the disturbance level determination unit 204.

The procedure of FIG. 7 is able to determine the disturbance levels of both heat haze and fog by properly setting a threshold X for the number of blocks and a threshold T for disturbance values.

In FIG. 7, when starting the processing (Start), the disturbance level determination unit 204 acquires the fog detection result 213, heat-haze detection result 214, or the like as the disturbance detection result of the analysis image (S701).

The disturbance level determination unit 204, which holds the disturbance detection results for all the blocks, updates the disturbance detection results using disturbance detection acquired in S701 (S702) and counts the number of blocks in which disturbance is detected (S703). When the disturbance detection results are not acquired, the disturbance level determination unit 204 does not update the held disturbance detection results. When the event detection unit 104 is configured to perform event detection by applying a mask region, the disturbance level determination unit 204 does not need to hold the disturbance detection result for a block at the position corresponding to the mask region.

In S704, the disturbance level determination unit 204 determines whether the number of blocks in which disturbance is detected is equal to or greater than X. When the number of blocks in which disturbance is detected is equal to or greater than X (YES), the disturbance level determination unit 204 proceeds to S705. When the number of blocks in which disturbance is detected is less than X (NO), the disturbance level determination unit 204 proceeds to S709.

The disturbance level determination unit 204 calculates the average of the disturbance values of the blocks in which the disturbance is detected (S705) and determines whether the average of the disturbance values is equal to or greater than T (S706). When the average of the disturbance values is equal to or greater than T (YES), the disturbance level determination unit 204 proceeds to S707. When the average of the disturbance values is less than T (NO), the disturbance level determination unit 204 proceeds to S708.

In S707, the disturbance level determination unit 204 sets the disturbance level to “high” and ends the processing (End).

In S708, the disturbance level determination unit 204 sets the disturbance level to “middle” and ends the processing (End).

In S709, the disturbance level determination unit 204 sets the disturbance level to “low” and ends the processing (End).

Next, a description is given of the operation of the image correction unit 103.

As described above, the image correction unit 103 of the first embodiment includes a capability of performing correction processes including fog correction, heat-haze correction, and sharpening (super-resolution) and is able to perform at least one of the processes for a full-frame image in real-time. The fog correction is useful for not only fog. The sharpening (super-resolution) is useful for event detection based on a small distant subject or the like.

The image correction unit 103 calculates the importance of each correction process based on the disturbance levels of fog, heat haze, and noise included in the inputted disturbance information 113 and then sorts the correction processes in given order of importance. The image correction unit 103 performs the correction processes in order of importance to an extent that the amount of processing allows. The image-processing device 1 uses a function g_{Fog( )} to calculate the importance of the correction process for fog from the disturbance level of fog, a function g_{HeatHaze( )} to calculate the importance of the correction process for fog from the disturbance level of heat haze, and a function g_{Sharpen( )} to calculate the importance of the sharpening (super-resolution) process from the disturbance level of noise, for example. The importance of correction processes is also defined for the three disturbance levels as shown in the following table.

TABLE 1

| | DISTURBANCE LEVEL | | |
|---|---|---|---|
| IMPORTANCE | LOW | MIDDLE | HIGH |
| FOG CORRECTION | 1 | 6 | 10 |
| HEAT-HAZE CORRECTION | 0 | 4 | 8 |
| SUPER-RESOLUTION | 4 | 2 | 0 |

This table is created based on the findings about which image correction process is required for the current input video image in the light of the disturbance levels thereof. In the first embodiment, image correction processes are prioritized in the light of the disturbance levels and the effects of image correction. Disturbances that cannot be improved by the correction processes are thus not addressed even if having significant adverse effects on event detection. Since the super-resolution process enhances noise, the importance of the super-resolution process is reduced as the disturbance level of noise increases. Moreover, in order to ensure real-time operation, the image-processing device 1 needs to perform the processes in order of priority to the extent that the amount of processing allows.

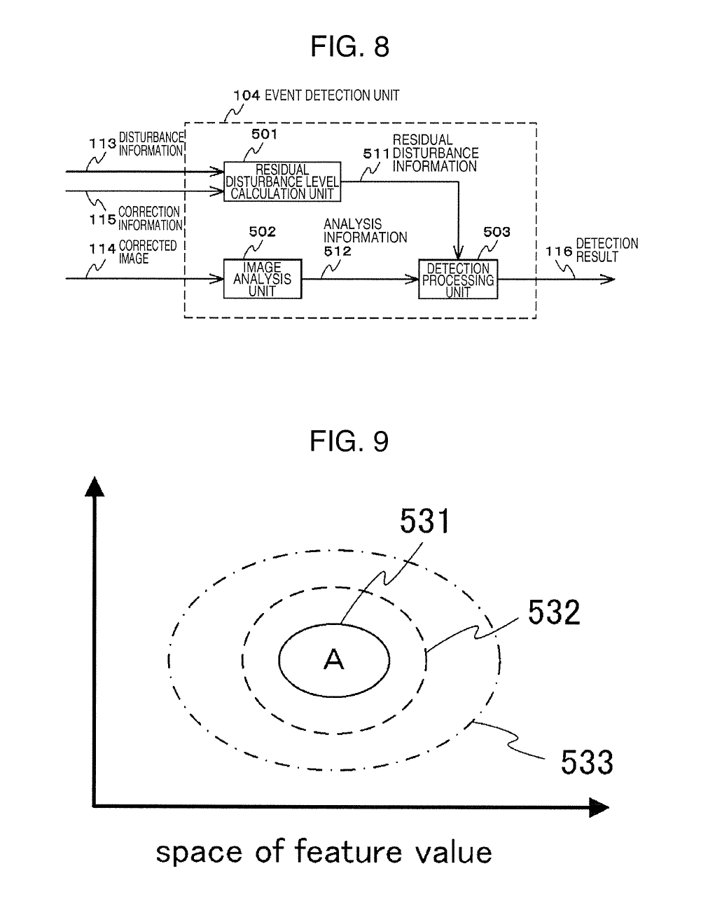

Next, a description is given of the event detection unit using FIG. 8.

FIG. 8 is a block diagram of the event detection unit 104 of the image-processing device 1.

The event detection unit 104 includes a residual disturbance level calculation unit 501, an image analysis unit 502, and a detection processing unit 503.

The residual disturbance level calculation unit 501 calculates the level of disturbance which must be included in the corrected image 114 using the inputted disturbance information 113 and correction information 115 and outputs the calculated level of disturbance as residual disturbance information 511.

The residual disturbance information 511 may represent the influences of noise such as fog and heat haze with three levels of “high”, “middle”, and “low”, for example.

When fog correction is performed in the image correction unit 103, as an example, the influence of fog is set to “low” or a level just below the original level. When fog correction is not performed in the image correction unit 103, the fog level of the disturbance information 113 is used directly.

When fog correction is performed in the image correction unit 103, the influence of heat haze is set to “low” or a level just below the original level. When heat-haze correction is not performed in the image correction unit 103, the heat-haze level of the disturbance information 113 is used directly.

When sharpening is performed in the image correction unit 103, the influence of noise is set to “low” in the case where the noise level of the disturbance information 113 is “low” and is set to “high” in the case where the noise level of the disturbance information 113 is “middle” or “high”. When sharpening is not performed in the image correction unit, the noise level of the disturbance information 113 is outputted directly.

Alternatively, when the disturbance levels in the disturbance information 113 have continuous values and the correction information 115 represents removed disturbances (degrees of improvements by correction) with continuous values, the residual disturbance levels can be calculated by the differences therebetween.

The image analysis unit 502 outputs a feature value x obtained by analyzing the corrected image 114 as analysis information 512.

The detection processing unit 503 detects an event from the analysis information 512 according to the residual disturbance information 511 and outputs detection result 116. For example, the detection processing unit 503 detects an event when the following expression (Ex. 2) is established.

[MATH. 3]

g(x)<T(Fog,HeatHaze,Noise) Ex. 2

Herein, g( ) is a detection function to detect a particular event. g( ) approaches 0 (or further decreases to a negative) as the likelihood of the particular event increases while increasing as the likelihood thereof decreases. T(Fog, HeatHaze, Noise) is a threshold function. Increasing the threshold in accordance with the residual disturbance level increases the false detection rate but reduces the number of misses. When the detection function incorporates a threshold in advance, like a linear discriminant function or SVM, the aforementioned T( ) is added to or reduced from the threshold to be applied.

FIG. 9 is a schematic diagram for explaining the operation of the threshold function T( ) in the detection processing unit 503.

The feature value x outputted from the image analysis unit 502 is distributed in a feature value space. Especially when the feature value space is optimized as a metric space, the feature value x corresponding to a certain event A is concentrated in a narrow area. When the disturbance level is higher, the feature value x is scattered and distributed in a wider area. In the first embodiment, when the residual disturbance is small, a small area 531 corresponding to a small threshold T( ) is applied, and the feature value within the small area 531 is determined as the event A. In a similar manner, when the disturbance level is middle, a medium area 532 is applied, and when the disturbance level is high, a large area 533 is applied.

The image-processing device 1 can perform the image correction process by using a central processing unit (CPU), a graphics processing unit (GPU), and field-programmable gate array (FPGA). The allowable amount of computation in the image-processing device 1 is determined by the utilization of the CPU and the like.

The image-processing device 1 may be equipped with a so-called learning function to store processes according to disturbance levels. The image-processing device 1 is thereby able to detect an event using optimal feature values.

### Second Embodiment

In a second embodiment, a description is given on the assumption that the imaging unit includes an image correction unit and the operation thereof cannot be freely controlled.

FIG. 9 is a block diagram illustrating an image correction unit 130 according to the second embodiment and the surrounding configuration.

An imaging unit 131 is different from the imaging unit 101 in incorporating the image correction unit 133. The imaging unit 131 outputs the setting parameters 112, including imaging parameters such as exposure time, aperture, zoom ratio, and use of an optical filter and the AGC gain value. The image correction unit 133 automatically performs appropriate image processing for the taken image based on the settings of the imaging unit 131, the imaging situation, and the like and outputs the processed image as the corrected image 114. The image correction unit 133 also outputs complete correction information 115 describing all of the correction processes applied to a raw image read out of the imaging element of the imaging unit 131. The correction information 115 may be narrowed to only information concerning major correction processes that can influence the resolution, the SN ratio, and the like. Such major correction processes can include backlight correction and fog correction, which are kinds of contrast correction, angle-of-view movement correction, heat-haze correction, super-resolution, and moreover image distortion correction of fisheye lenses.

A disturbance estimation unit 132 receives the setting parameters 112, corrected image 114, and correction information 115 and estimates levels of disturbances remaining in the corrected image 114 by a fully-connected perceptron or a support vector machine (SVM) to output the estimated levels as residual disturbance information 531. The residual disturbance information 531 includes plural components, which may be three components of fog, heat-haze, and noise similar to the residual disturbance information 511. Alternatively, the residual disturbance information 531 may be distilled into four components of another criteria: luminance error (noise), spatial error, time fluctuation, and color error, for example or a feature value as a mixture thereof. Moreover, the residual disturbance information 531 may be represented by three levels or have continuous values similarly to the residual disturbance information 511.

When the image correction unit 133 includes necessary abilities to correct fog, heat-haze, and the like, the disturbance estimation unit 132 does not need to detect the same from the corrected image 114 and only needs to simply input the setting parameters 112 and correction information 115 to a perceptron or the like.

The perceptron or the like is assumed to be previously trained and may perform online learning to increase the generalization capability for the installation situation of the camera and the imaging environment. The online learning is performed by acquiring the disturbance level corresponding to each component of the residual disturbance information 531 through another method, such as that the disturbance level is calculated from the corrected image 114 by a means like the fog influence detection unit 202 or that the disturbance level is given by a person evaluating the corrected image 114, and using the acquired disturbance level as training data.

An event detection unit 134 receives the corrected image 114 and residual disturbance information 531 to perform event detection on the corrected image 114 so that the false alarm rate and miss rate are optimized in the light of the residual disturbance information 531.

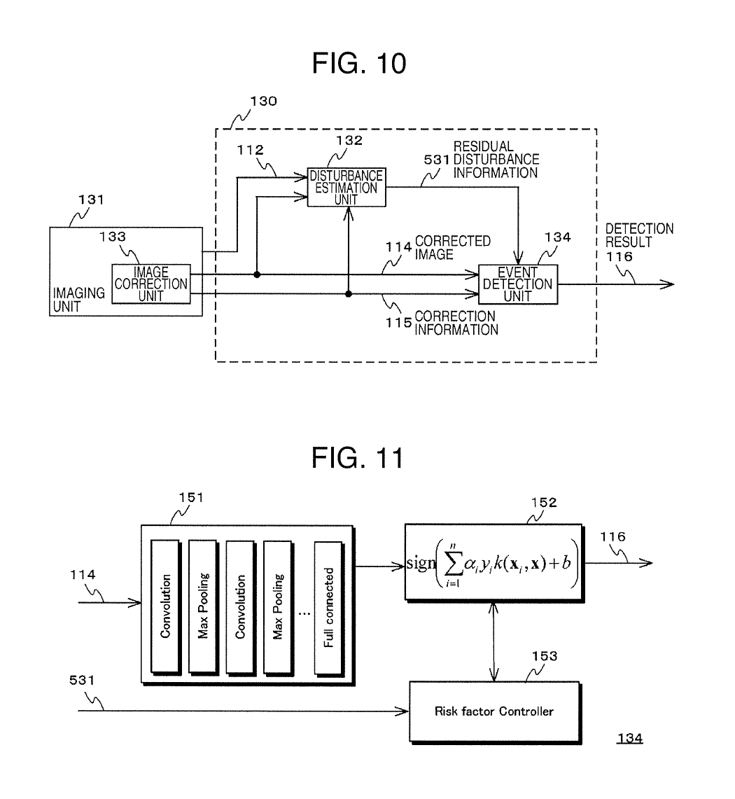

As illustrated in FIG. 10, the event detection unit 134 of the second embodiment includes a convolutional neural network (CNN) 151, a support vector machine (SVM) classifier 152, and a risk factor controller 153.

The CNN 151 receives pixel values from the event detection unit 134 and repeatedly applies a convolutional layer and a max pooling layer several times while reducing the number of data sets and then applies a fully-connected layer if necessary, thus outputting plural values (a feature vector). This feature vector corresponds to the analysis information 512 in the first embodiment. The correction information 115 may be inputted in a middle layer of the CNN 151 (the fully-connected layer, for example).

The SVM classifier 152 is a soft margin SVM and outputs a classification result (hard decision of true or false) for each particular event to be detected. The SVM classifier 152 can include plural two-class SVMs or one-class SVMs for each event. The learning uses a loss function that gives a penalty to a wrong answer, such as a hinge function.

The risk factor controller 153 controls learning of the SVM classifier 152 for each combination of plural disturbance levels indicated by the residual disturbance information 531. As an example, the risk factor controller 153 sets the results of learning using the same kernel and support vector of the SVM classifier 152 independently of the disturbance levels, as representative learning results or learning results for the lowest disturbance level. For the other disturbance levels, learning is performed based on the representative learning results or the like. In this process, the risk factor controller 153 stores all of the samples used for the learning or holds the parameters or function values of the loss function of C-SVM, v trick, or the like. The risk factor controller 153 uses a probably approximately correct (PAC) model to evaluate the risk of incorrect classifications of the SVM classifier 152 (to be more precise, the risk that the SVM classifier 152 learns incorrect classifications with large generalization errors) for each combination of the aforementioned disturbance levels for tuning. The tuning is an action corresponding to the threshold function T( ) in the first embodiment and is intended to provide a low miss rate. The tuning is accordingly performed so that the risk factor is equal to or lower than a desired miss rate. For example, the SVM classifier 152 is caused to learn again by adjusting the threshold b of the classification function of the SVM classifier 152 or updating the parameters including C, v, σ, and the like. The control of the risk factor may be limited so that the false alarm rate does not exceed the allowable limit. The tuning of the second embodiment can be independently performed for each event to be detected and is able to optimize the miss rate and false alarm rate according to the degree of threat of the event.

### INDUSTRIAL APPLICABILITY

The present invention is applicable to image processing such as video content analyses to detect unwanted or dangerous situations from video footage taken by monitoring cameras and the like or extract desired events or meta data from TV program materials.

### REFERENCE SIGNS LIST

1, 100 IMAGE-PROCESSING DEVICE
101 IMAGING UNIT
102 DISTURBANCE DETECTION UNIT
103 IMAGE CORRECTION UNIT
104 EVENT DETECTION UNIT
111 INPUT IMAGE
112 SETTING PARAMETER
113 IMAGE DEGRADATION INFORMATION
114 CORRECTED IMAGE
115 CORRECTION INFORMATION
116 ANALYSIS RESULT
201 ANALYSIS IMAGE EXTRACTION UNIT
202 FOG INFLUENCE DETECTION UNIT
203 HEAT-HAZE INFLUENCE DETECTION UNIT
204 DISTURBANCE LEVEL DETERMINATION UNIT
211 FOG ANALYSIS TARGET IMAGE
212 HEAT-HAZE ANALYSIS TARGET IMAGE
213 FOG DETECTION RESULT
214 HEAT-HAZE DETECTION RESULT
301 FOG CORRECTION PROCESSING UNIT
302 IMAGE COMPARISON UNIT
303 FOG INFLUENCE CALCULATION UNIT
311 FOG CORRECTED IMAGE
312 DIFFERENCE INFORMATION
401 FLUCTUATION-ROBUST MOVING OBJECT DETECTION UNIT
402 BACKGROUND REGION COMPARISON UNIT
403 HEAT-HAZE INFLUENCE CALCULATION UNIT
411 MOVING OBJECT REGION INFORMATION
412 BACKGROUND REGION DIFFERENCE INFORMATION
501 RESIDUAL DISTURBANCE LEVEL CALCULATION UNIT
502 IMAGE ANALYSIS UNIT
503 DETECTION PROCESSING UNIT
511 RESIDUAL DISTURBANCE INFORMATION
512 ANALYSIS INFORMATION

1. An image-processing device to detect a particular event from an image, comprising:
a disturbance detector which analyzes an input image to detect influences of a plurality of disturbances on the input image and outputs the detected influences as disturbance information;
an image corrector which applies a correction process to the input image in accordance with the disturbance information and outputs the corrected image and correction information indicating the actually applied correction process; and
an event detector which estimates degrees of a plurality of disturbances remaining in the corrected image based on the disturbance information and the correction information and uses a detection process selected in accordance with the degrees of disturbances to detect the particular event.

2. The image-processing device according to claim 1, wherein
the disturbance detector detects and updates influences of the plurality of disturbances in a range of a partial region while changing the position of the partial region each time of receiving the input image and evaluates on a multiple point scale, each of the influences of the plurality of disturbances on the entire input image.

3. The image-processing device according to claim 2, wherein
the image corrector translates each of the influences of the disturbances evaluated on the multiple point scale into importance of correction and executes correction processes corresponding to the plurality of disturbances in order of the importance to an extent that the amount of processing allows, and
the importance is determined in the light of an improvement effect by the correction.

4. The image-processing device according to claim 3, wherein
the event detector includes:
a residual disturbance level calculator which calculates degrees of the plurality of remaining disturbances from the disturbance information and the correction information;
an image analyzer which extracts a feature value from the corrected image; and
a detection processor which uses a function of the degrees of the plurality of remaining disturbances to determine the particular event from the feature value, the function changing a region where the particular event is to be detected in a feature value space.

5. The image-processing device according to claim 4, wherein
the function operates to expand the region to be detected as the degrees of the plurality of remaining disturbances increases and maintain a low miss rate of the detection processor independently of the degree of disturbance.

6. The image-processing device according to claim 5, wherein
the detection processor is a support vector machine, and the function changes a threshold in a classification function of the support vector machine.
